(19) United States
(12) Patent Application Publication
(10) Pub. No.: US 2023/0332821 A1
(43) Pub. Date: Oct. 19, 2023

(54) DEAD-FRONT USER INTERFACE

(71) Applicant: Electrolux Home Products, Inc., Charlotte, NC (US)

(72) Inventor: Joshua Hanson, Huntersville, NC (US)

(21) Appl. No.: 17/721,503

(22) Filed: Apr. 15, 2022

(51) Int. Cl. F25D 23/02; F25D 29/00; G06F 3/04817; G06F 3/041

(52) U.S. Cl. CPC F25D 23/028; F25D 29/005; G06F 3/04817; G06F 3/0412; F25D 2400/361

(57) ABSTRACT

A dead front assembly adapted for an electronic user interface. The dead front assembly includes a masking layer, a coating layer, and a vacuum metalized layer. The masking layer includes an opening defining a two-dimensional graphic for allowing emitted light to be transmitted therethrough to display user information. The vacuum metalized layer includes a translucent, metallic coating that serves to conceal the masking layer when viewing the user interface from a front external view thereof. The coating layer is adapted to match a flat, non-metallic color of a component in which the user interface is received or mounted.

### FIELD OF THE INVENTION

This application generally relates to user interfaces, and more particularly to a novel dead-front user interface assembly including a masking layer and a vacuum metalized layer adapted to enhance the optical clarity of illuminated text and/or iconography.

### BACKGROUND

Consumer appliances generally include one or more user interfaces configured to facilitate the interaction between a user and the appliance. Many user interfaces provide visual feedback regarding the status of a product feature in the form of visible text and/or iconography. To enhance the simplicity of operating an appliance, dead-front assemblies (comprising overlays or panels) were developed to make such text or iconography only visible under certain circumstances, for example, in response to a user's operation of the user interface or based on the status of a particular feature. To accomplish this purpose, some dead-front assemblies include a masking layer defining one or more openings for the passage of light to selectively illuminate text and/or iconography on the user interface. The masking layer also serves to block light from passing through concealed portions of the masking layer. To perform this function, a masking layer is generally made with dark-colored inks (e.g., black or navy blue) that effectively absorb light energy.

Dead front assemblies also generally include a coating layer intended to match a color of the user interface or the appliance in which the dead front assembly is received or mounted. But applying a light-colored coating layer (e.g., a white layer) over a dark-colored masking layer (e.g., black layer) is not feasible due to color bleed, whereby the intended color of the coating layer is altered by the color of the masking layer. Accordingly, some manufacturers use a masking layer comprising a light color (e.g., gray) to preclude color bleed. However, concealed portions of a light-colored masking layer may still glow when light is illuminated thereon, thereby compromising the optical clarity of the text and/or iconography illuminated on the user interface. Alternatively, some manufacturers apply multiple coating layers over a masking layer to conceal the evidence of the underlying masking layer. However, each additional coating layer reduces the amount of light that may pass through the dead front assembly, thereby resulting in blurry or dimly illuminated text or iconography. Therefore, it is desired to provide an improved dead front assembly that can resolve the foregoing issues.

### BRIEF SUMMARY

The following presents a simplified summary of the disclosure in order to provide a basic understanding of some example aspects described in the detailed description. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

In accordance with one aspect, there is provided a dead front assembly for a user interface of a component. The dead front assembly includes a masking layer, a coating layer, and a vacuum metalized layer. The masking layer includes an opening defining a two-dimensional graphic. The vacuum metalized layer is disposed between the masking layer and the coating layer and is configured to conceal the masking layer and preserve an intended color of the coating layer. The coating layer is configured to match a flat, non-metallic color of the component and conceal the vacuum metalized layer.

In accordance with another aspect, there is provided a user interface for a component. The user interface includes an illumination element configured to transmit emitted light. A molded component is arranged proximate the illumination element. In addition, a dead front assembly is disposed on the molded component. The dead front assembly includes a masking layer, a coating layer, and a vacuum metalized layer that is disposed between the masking layer and the coating layer. The masking layer includes an opening defining a two-dimensional graphic. Emitted light is selectively transmitted through the opening to convey user information. Further, the coating layer is configured to match a color of said component.

In accordance with yet another aspect, a method of forming a user interface of a component includes producing a dead front assembly by arranging a vacuum metalized layer between a coating layer configured to match a color of and a masking layer, and a masking layer defining a two-dimensional graphic for the passage of light therethrough. The method also includes applying the dead front assembly onto a molded component forming part of the user interface.

### BRIEF DESCRIPTION OF THE DRAWINGS

The accompanying drawings, which are not necessarily to scale, show various aspects of the disclosure.

FIG. 1 is a front perspective view of a household refrigeration appliance shown with an example dead-front user interface as herein disclosed;

FIG. 2 is an enlarged front view of the dead-front user interface of FIG. 1 in a state wherein user information is made visible;

FIG. 3 is an enlarged front view of the dead-front user interface of FIG. 1 in a state wherein the user information is concealed;

FIG. 4 is an exploded top perspective view of the dead-front user interface of FIG. 1;

FIG. 5A illustrates an example masking layer for a dead-front user interface according to a second embodiment;

FIG. 5B illustrates another example masking layer for a dead-front user interface according to a third embodiment;

FIG. 5C illustrates another example masking layer for a dead-front user interface according to a fourth embodiment;

FIG. 5D illustrates another example masking layer for a dead-front user interface according to a fifth embodiment;

FIG. 5E illustrates another example masking layer for a dead-front user interface according to a sixth embodiment;

FIG. 5F illustrates another example masking layer for a dead-front user interface according to a seventh embodiment;

FIG. 6A is a partial, exploded bottom perspective view of the dead-front user interface of FIG. 1;

FIG. 6B is a partial, exploded sectional view of the dead-front user interface of FIG. 1, taken along line 6B-6B of FIG. 2, in a state wherein light is being transmitted through a vacuum metalized layer of the dead-front user interface; and

FIG. 6C is a partial, exploded sectional view of the dead-front user interface of FIG. 1, taken along line 6C-6C of FIG. 3, illustrating the reflective attributes of the vacuum metalized layer of the dead-front user interface.

### DETAILED DESCRIPTION

The present disclosure generally relates to user interfaces for consumer appliances and/or devices, and more particularly to a dead-front assembly configured for use in light-colored (e.g., white) user interfaces and components in which the dead front assembly is received or mounted. Although the various examples herein illustrate a dead-front assembly described for use in a user interface of a refrigerator appliance, it should be understood that the various inventions described herein are also suitable for use in other devices, including, but not limited to, dishwashers, microwaves, ovens, ranges, clothes washers, dryers, coffee makers, blenders, air-conditioners, small electronic devices (e.g., thermostats, air-purifiers, voice assistant devices), office equipment, vehicles, industrial machinery, and the like.

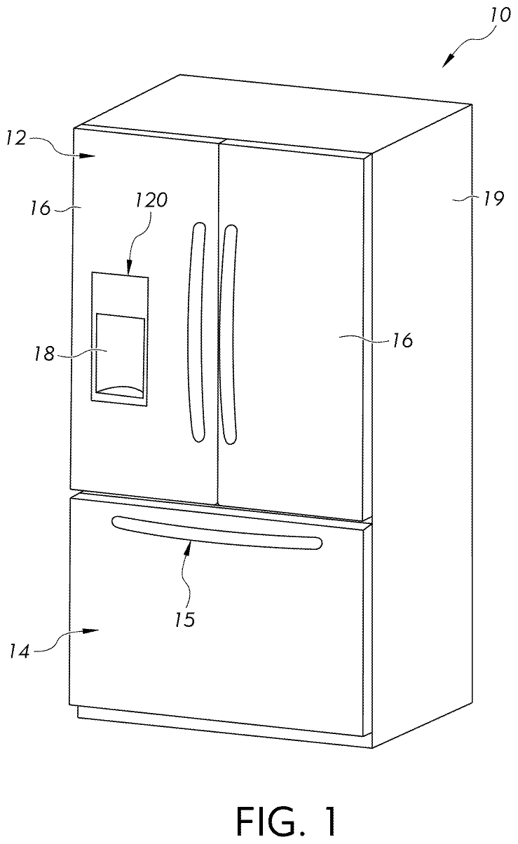

Turning now to the drawings, FIG. 1 illustrates a refrigerator appliance in the form of a domestic refrigerator, indicated generally as 10. The refrigerator 10 includes a fresh food storage compartment 12 and a freezer storage compartment 14. One or more doors 16 are pivotally coupled to a cabinet 19 of the refrigerator 10 to restrict and grant access to the fresh food compartment 12. A dispenser 18 is disposed on one of the doors 16 for dispensing ice and water therefrom. A dead-front user interface 120 is arranged above the dispenser 18 and is operable to control ice-making production, cabinet lighting, compartment temperatures, among other features. Of course, it is to be understood that a dead-front user interface can be arranged variously about the appliance, including both external locations and internal locations.

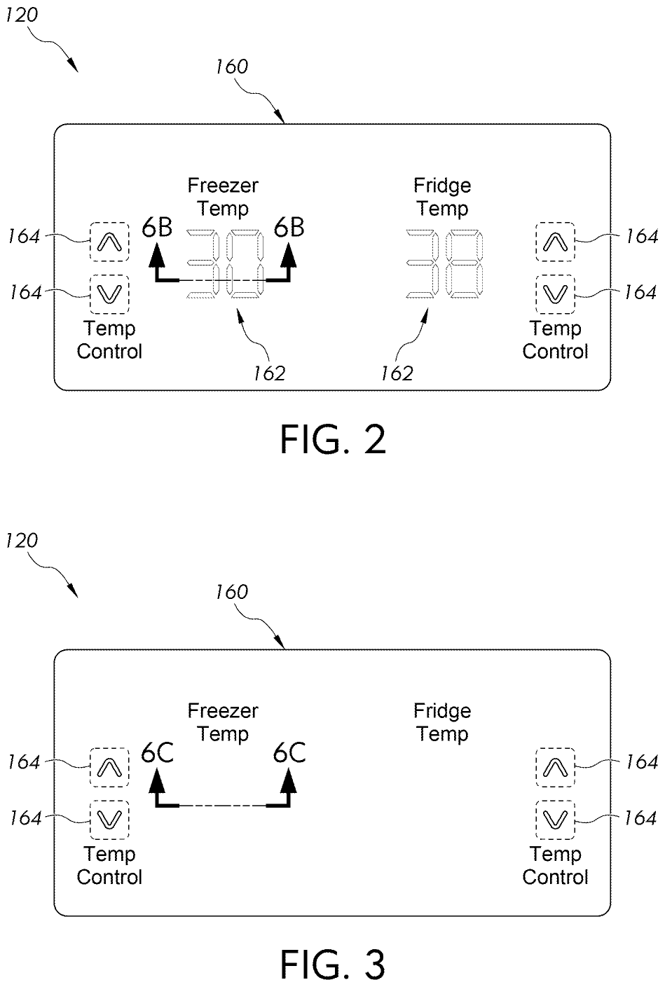

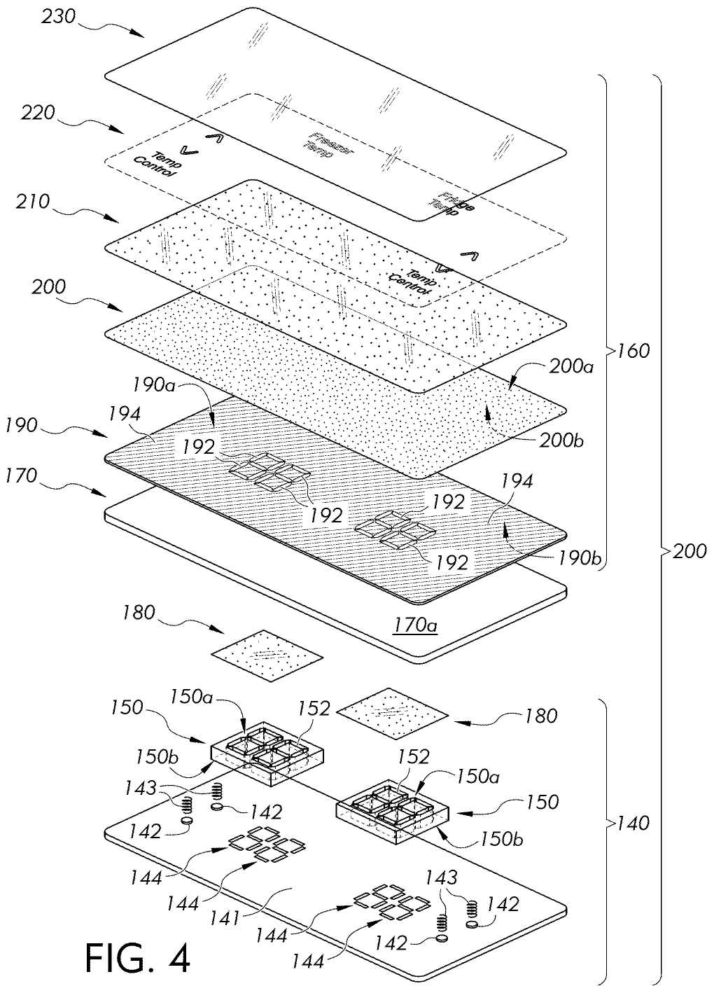

Referring to FIGS. 2 and 3, an enlarged portion of the dead-front user interface 120 is shown illustrating temperature control functions of the appliance 10 (FIG. 1). The user interface 120 comprises a dead front assembly 160 configured to selectively display user information 162, i.e., temperature information. While the illustrated examples herein relate to selectively displaying temperature information for a refrigerator appliance, it should be understood that various inventions described herein may be adapted to selectively display other examples of information for other appliances or components, including, but not limited to, filter replacement reminders, timer adjustments, lighting, warning signals, the time, drying or washing cycle information, oven settings, water refill indicators, vehicle status, and the like.

FIG. 2 illustrates the user interface 120 in a state wherein the user information 162 is made visible, and FIG. 3 illustrates the user interface 120 in a state wherein the user information 162 is concealed by the dead-front assembly 160. In the example shown, the user interface 120 includes touch zones 164 which may be touched by a user to adjust the respective temperatures of the fresh food and freezer compartments 12 and 14 of the appliance 10. For ease of illustration, the touch zones 164 are depicted with dotted lines that generally would be unnoticeable when viewing a front of the user interface 120. In this example, the touch zones 164 are illustrated as capacitive touch buttons which utilize capacitive sensors, although it is to be appreciated that various other types of electronic buttons or switches can be utilized to manipulate the user interface.

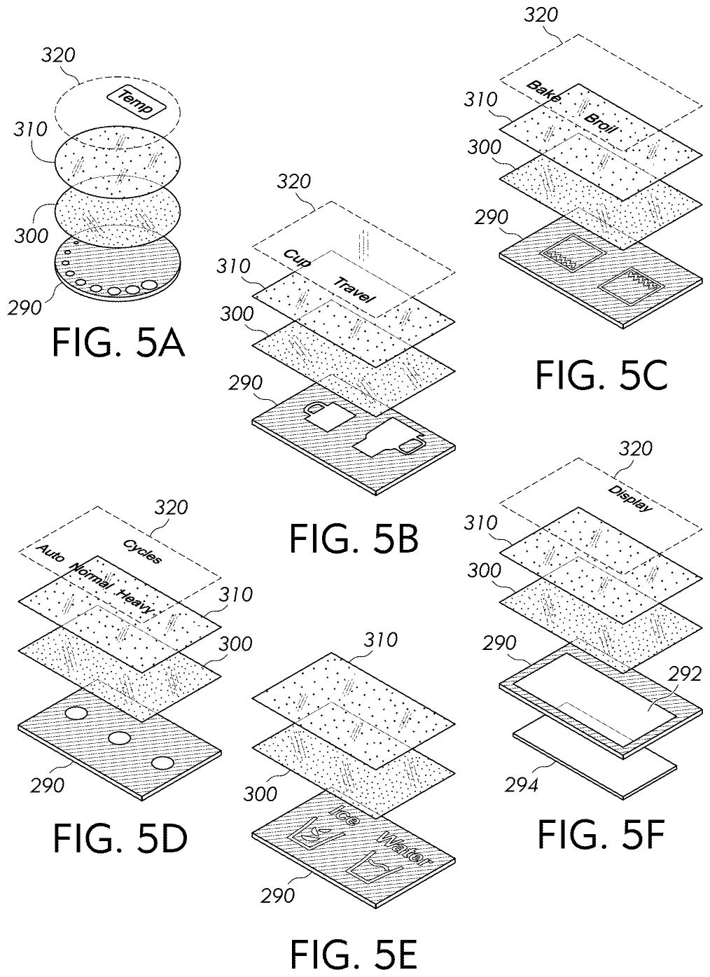

Referring to FIG. 4, an exploded view of the user interface 120 is shown. In the illustrated example, the user interface 120 comprises an example dead front assembly 160 disposed about a molded part 170 and a printed circuit board assembly 140.

The printed circuit board assembly 140 includes a printed circuit board 141 and a plurality of capacitive sensors 142 (i.e., arranged beneath the touch zones 164 as part of the capacitive touch buttons) and light elements 144 (e.g., illumination elements such as LEDS, bulbs, lamps, and the like) arranged thereon. The light elements 144 are selectively illuminable when the capacitive sensors 142 are actuated. In some embodiments, the capacitive sensors 142 are actuated when a user presses the touch zones 164. In such embodiments, it is contemplated that conductive spring elements 143 may be disposed between the touch zones 164 and the capacitive sensors 142 to facilitate actuating the capacitive sensors 142. For example, each conductive spring elements 143 can be affixed to the printed circuit board 141 about one capacitive sensor 142, and can extend upwards into contact with a bottom surface of the molded part 170. In some embodiments, actuating the capacitive sensors 142 will cause a controller (not shown) to actuate the corresponding light elements 144 arranged on the printed circuit board 141. While the examples described herein disclose capacitive sensors 142, it should be appreciated that other examples of control sensors may be utilized to selectively actuate the light elements, for example, resistive touch sensors, infrared touch sensors, tactile control elements, rotary encoders, proximity sensors, timers, and the like.

The printed circuit board assembly 140 may include a plurality of light guides 150 arranged on the board 141 aligned with the plurality of light elements 144 disposed thereon. Specifically, each light guide 150 may comprise a plurality of openings 152 extending between an upper surface 150a and a lower surface 150b thereof. Each opening 152 is positioned to direct light emitted from a respective light element 144 toward a corresponding opening 192 in a masking layer 190 of the dead front assembly 160, as discussed in detail below.

Still referring to FIG. 4, tape layers 180 are applied over the respective light guides 150. In particular, each tape layer 180 comprises a diffusion film (e.g., printed via a cloudy or milky white ink) that causes light passing through the respective tape layer 180 to be transmitted more uniformly, e.g., for dispersing the light in multiple directions to reduce glare. In other embodiments, a diffusion layer (not shown) may form part of the dead front assembly 160, for example, when the dead front assembly is provided in the form of an in-mold or pressure sensitive label (e.g., with a pressure-sensitive adhesive). Yet, in other embodiments, it is contemplated that the molded part 170 may comprise opacity, causing light transmitted therethrough to be dispersed more uniformly.

The molded part 170 embodies a plastic component formed during a plastic injection process. Where capacitive touch sensors 142 (FIG. 4) are used, the plastic molded part 170 acts as a dielectric surface. Yet, in other embodiments, it is contemplated that the molded part may embody glass or other forms of translucent or transparent materials.

In the illustrated embodiment, the molded part 170 is arranged between the printed circuit board assembly 140 and the dead front assembly 160. In some embodiments, the molded part 170 is formed with the dead front assembly 160 integrally applied thereon via an in mold decorative process. In such embodiments, it is contemplated that a transfer foil (not shown) is utilized to apply the dead front assembly 160 to molten plastic (e.g., injected into a mold cavity) during the plastic injection process. It is also contemplated that the molded part 170 may be formed with the dead front assembly 160 integrally formed thereon, for example, in embodiments wherein the dead front assembly is provided in the form of an in-mold label that is fused to molten plastic during the plastic injection process.

In other embodiments, the molded part 170 embodies an independently formed component defining a substrate for receiving the dead front assembly 160 thereon, for example, in embodiments wherein the dead front assembly 160 is provided in the form of a pressure sensitive label that is applied onto an upper surface 170a of the molded part 170. In such embodiments, it is contemplated that the dead front assembly 160 may comprise a plastic carrier (not shown) that may be peeled off to expose an adhesive printed onto a lower-most layer (e.g., the masking layer) of the dead front assembly 160, for example, when applying the dead front assembly 160 to the molded part 170.

It is contemplated that the molded part 170 may be made of a transparent material to enable light transmitted from the printed circuit board assembly 140 to pass therethrough. In some embodiments, it is contemplated that the molded part 170 may be easily deformable in the vicinity of the touch zones 164 FIG. 2), for example, when resistive touch sensors or capacitive sensors are utilized to actuate the light elements.

Still referring to FIG. 4, the dead front assembly 160 comprises a plurality of layers provided in a stacked arrangement thereon. In the illustrated embodiment, the plurality of layers may include some or all of a masking layer 190, a vacuum-metalized layer 200, a coating layer 210, an indicia layer 220, and a hard coat protective layer 230. In some embodiments, each respective layer 190, 210, 220, or 230 embodies ink that is transferred to the molded part 170 during an in-mold decoration process, e.g., via a transfer foil. In such embodiments, it is contemplated that some or all of the layers 190, 210, 220 and 230 may be formed via a gravure printing process.

In some embodiments, the respective layers 190, 210, 220, and 230 may be separately printed to form part of a label, for example, via a silk screen printing (e.g., serigraphy) or flexographic printing process. In such embodiments, it is contemplated that some of the layers may be provided in sheet stock, for example, the hard coat layer 230 and/or the vacuum metalized layer 200. In these embodiments, it is contemplated that the hard coat layer 230 or the vacuum metalized layer 200 may define a substrate for printing other layers thereon.

Turning now to each respective layer, the masking layer 190 is disposed on the upper surface 170a of the molded part 170. The masking layer 190 includes an upper surface 190a and a lower surface 190b. A plurality of openings 192 extend between the upper surface 190a and the lower surface 190b and are aligned with the light elements 144 on the printed circuit board assembly 140 and with the plurality of openings 152 of the light guide 150. It is contemplated that the openings 192 may be formed via serigraphy or lithography.

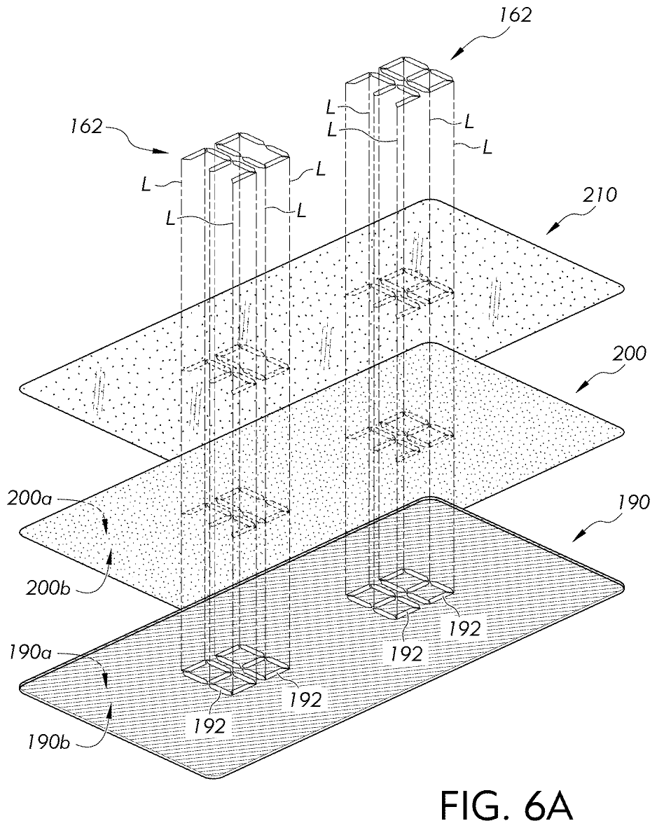

In general, the plurality of openings 192 define a two-dimensional graphic comprising visual iconography or text that is selectively made visible (i.e., illuminated) by the user interface 120. In the illustrated embodiment, the plurality of openings 192 define a plurality of seven-segment displays for selectively displaying numerical temperature information on the user interface 120. Yet, it should be appreciated that the plurality of openings 192 may define other examples of visual iconography or text, for example, when it is desired to selectively display other forms of user information. For instance, and referring to FIGS. 5A-5E, various non-limiting examples of masking layers 290 defining other examples of user information are shown in relation to vacuum metalized layers 300, coating layers 310, and indicia layers 320, respectively. For example, FIG. 5A illustrates a temperature setting for a refrigerator appliance and FIG. 5B illustrates a coffee cup size (e.g., conventional mug, travel mug) for a coffee maker. In other examples, FIG. 5C illustrates a heating mode (e.g., bake, broil) for an oven appliance, FIG. 5D illustrates a setting for a dishwasher appliance, and FIG. 5E illustrates ice and water dispenser iconography for a user interface of a refrigerator appliance. Referring to FIG. 5F, in some embodiments, it is contemplated that the masking layer 290 may comprise a single opening, for example, to define a window 292 for enabling an electronic display 294 (e.g., an LCD screen) disposed beneath the masking layer 290 to selectively be made visible to a user. In this manner, it should be appreciated that a wide variety of masking layers may be adapted for use with the various examples of dead front assemblies disclosed herein.

With reference to FIG. 4, the masking layer 190 preferably comprises one or more layers of an opaque (e.g., black or navy blue) or chrome ink configured to absorb light energy such that light transmitted from the printed circuit board assembly 140 does not illuminate through masked or concealed portions 194 of the masking layer 190. In this manner, utilizing a black, navy blue, or chrome ink helps preclude the concealed portions 194 of the masking layer 190 (and therefore the layers above) from glowing and being discernible when viewing the user interface 120 from a front external view thereof. This aspect of the present disclosure is particularly beneficial for enhancing the optical clarity of the user information 162 (FIG. 2) displayed on the user interface 120 because of the more pronounced contrast between the masked and unmasked portions (e.g., 194 and 192) of the masking layer 190.

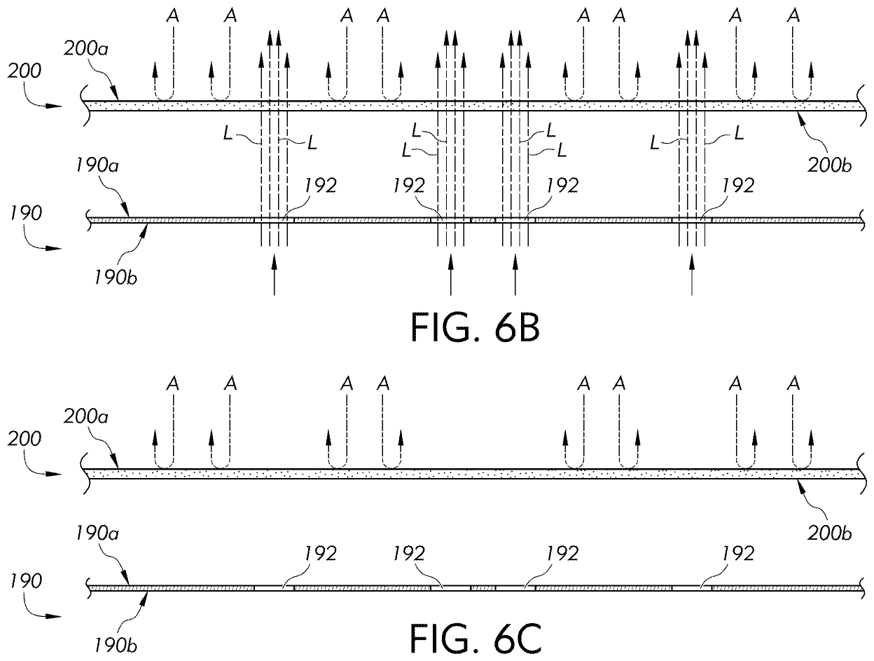

Still referring to FIG. 4, the vacuum metalized layer 200 embodies a translucent layer (e.g., a semi-opaque layer) that enables light L (FIGS. 6A-6C) emitted from the light elements 144 of the printed circuit board assembly 140 to be transmitted therethrough. In some embodiments, it is contemplated that a vacuum metallization process may be performed on some or all of the upper layers (e.g., 210, 220, 230) to form the vacuum metalized layer 200, for example, when the dead front assembly 160 is integrally formed with the molded part 170 as an in-mold decoration. However, as noted above, it is also contemplated that the vacuum metalized layer 200 may be provided in sheet stock, for example, when the dead front assembly 160 is provided in the form of an in-mold or pressure sensitive label.

Distinctively, the vacuum metalized layer 200 serves to conceal structure disposed beneath the vacuum metalizing layer 200, i.e., the underlying masking layer 190, the molded part 170, and the printed circuit board assembly 140. To perform this function, the vacuum metalized layer 200 comprises a thin layer of a reflective metallic coating (e.g., silver, tin, or gold) that serves to reflect ambient light A (to thereby conceal the underlying masking layer 190) while being translucent to light L emitted from light emitting structure (e.g., LEDs or similar) on the printed circuit board assembly 140.

Specifically, as shown in FIGS. 6B and 6C, the vacuum metalized layer 200 is reflective to ambient light A striking the upper surface 200a of the vacuum metalized layer 200, for example, light from an external environment (e.g., light in a household, or office space). In this manner, the vacuum metalized layer 200 acts as a mirror that serves to conceal the underlying structure disposed beneath the vacuum metalized layer 200, e.g., when viewing the user interface 120 from a front external view thereof. However, because this layer 200 is translucent, the emitted light L striking a lower surface 200b of the vacuum metalized layer 200 (i.e., light emitted from the printed circuit board assembly 140) may pass through the vacuum metalized layer 200 to thereby illuminate the user information 162 (FIG. 2) on the user interface 120.

Additionally, because the vacuum metalized layer 200 comprises a metallic coating (e.g., gold, tin, silver), it has a significantly lighter color than the underlying masking layer 190, which preferably comprises a dark-colored ink (e.g., black, navy blue) as discussed in detail above. In this manner, the vacuum metalized layer 200 serves as an effective primer for enabling a light-colored coating layer 210 (e.g., a non-black color such as white) to be printed thereon such that the color of the masking layer 190 does not bleed through and alter the color of the coating layer 210. In other words, the vacuum metalized layer 200 is configured to preserve the intended color of the masking layer 190, e.g., such that the intended color of the masking layer is not altered (via color bleed) based on the darker colors of the underlying layers, for example, a black or navy-blue masking layer. This aspect of the disclosure is also beneficial for reducing the number of coating layers 210 printed on the masking layer 190, because absent the vacuum metalized layer 200, multiple coating layers 210 (e.g., of a light, non-black color such as white or gray) would be required to conceal the darker color of the underlying masking layer 290.

Returning to FIG. 4, the coating layer 210 embodies a layer formed on the upper surface 200a of the vacuum metalized layer 200 for aesthetic or decorative purposes, for example, to match or mimic the color of the user interface 120 or the component (e.g., an appliance, machinery, an electronic device etc.) in which the user interface 120 is received or mounted. In embodiments wherein the color of the user interface or the component comprises a light, flat color (e.g., a non-black color such as white, light gray, or light blue, etc.), the coating layer 210 is printed utilizing a light-colored ink that matches and blends in seamlessly with the user interface and/or the component. In some embodiments, the coating layer 210 is a flat (substantially uniform), non-metallic color that is identical in tone and hue. In other embodiments, it is also contemplated that textures may be used in the coating layer 210, for example, checkered or dotted textures.

Because the vacuum metalized layer 200 serves as an effective primer, a relatively light-colored (e.g., white, light blue, grey) coating layer 210 may be printed over the vacuum metalized layer 200 (thereby concealing the vacuum metalized layer and the masking layer) in one pass without being susceptible to color bleed, e.g., due to a darker-colored masking layer disposed beneath. This aspect of the present disclosure is particularly beneficial for enabling light transmitted through the coating layer 210 to remain optically clear. This is in distinction to embodiments wherein multiple coating layers are required to form a dead front assembly, which adversely affects the resulting clarity and color of the user information 162 (FIG. 2) displayed on the user interface 120.

With reference to FIGS. 4 and 5A-5F, in some embodiments, an indicia layer 220 or 320 is formed on the coating layer 210 that always remains visible from a front external view thereof irrespective of an operational state of the printed circuit board assembly 140 (FIG. 4), e.g., the plurality of illumination elements 144 arranged thereon. In the illustrated examples, the indicia layer 220 or 320 is outlined with dotted lines for ease of illustration. The indicia layer 220 or 320 embodies a layer with two-dimensional iconography (e.g., arrows) and/or text (e.g., Freezer temp, Fridge Temp, Temp Control, etc.) that is printed on the coating layer 210. Specifically, the iconography and/or text of the indicia layer 220 serves to supplement the user information 162 (FIG. 2) selectively displayed by the user interface 120. In the various examples, FIG. 5A illustrates an indicia layer 320 defining text (the abbreviation “Temp”) accompanying iconography (e.g., openings corresponding to a temperature setting) for a user interface of a refrigerator appliance. In another example, FIG. 5B illustrates an indicia layer 320 defining text (the words “cup” and “travel”) accompanying iconography (e.g., openings illustrating a coffee cup size) for a user interface of a coffee maker. In yet another example, FIG. 5C illustrates an indicia layer 320 defining text (e.g., the words “Bake” and “Broil”) accompanying iconography (e.g., openings illustrating lower and upper heating elements) for a user interface of an oven. In yet a further example, FIG. 5D illustrates text (e.g., dishwasher or washing machine cycle settings) accompanying iconography (e.g., openings corresponding to a cycle setting) for a user interface of a dishwasher.

Although, in other embodiments, it is contemplated that the dead front assembly 160 may not require an indicia layer 220 (see, e.g., FIG. 5F), for example, in such embodiments wherein the user interface 120 is entirely dead fronted (e.g., normally concealed) such that all user-facing information is only displayed when the light elements 144 of the printed circuit board assembly 140 are actuated, see, e.g., FIG. 5E illustrating ice and water dispenser iconography for a user interface of a refrigerator appliance.

Referring to FIG. 4, the dead front assembly 160 may optionally include a hard coat layer 230 formed on the indicia layer 220. The hard coat layer 230 embodies an external-most layer of the dead front assembly 160, i.e., a user facing layer. Because the dead front assembly 160 is expected to be touched by a user (e.g., when changing a temperature in the illustrated embodiments), the hard coat layer 230 comprises an ink or other coating which has a relatively high hardness that is resistant to scratches and that may further be configured to repel a majority of oils that otherwise would deposit on this layer from a user's finger (i.e., fingerprint resistance). In such embodiments, the hard coat layer 230 serves to repel such oils from microscopic pores of this layer 230, thereby precluding visible smudges from being deposited on the user interface 120. In some embodiments, it is contemplated that the hard coat layer 230 comprises a satin texture finish including small, microscopic pores, resulting in a smooth but non-glossy surface.

Additionally, the hard coat layer 230 serves to maintain the optical clarity of the user information 162 (FIG. 2) transmitted through the hard coat layer 230. To accomplish this function, the hard coat layer 230 comprises a texture that causes external, ambient light to gather at and reflect off the layer 230, while concurrently enabling light from the printed circuit board assembly 140 to be transmitted through the hard coat layer 230.

In summary, the dead front assemblies according to the various inventions disclosed herein effectively enhance the optical clarity of illuminable iconography and text displayed by a user interface. Additionally, according to the present disclosure, the inventions facilitate implementing light-colored dead front user interfaces for use in light-colored components (e.g., white appliances, devices, equipment, etc.).

While the various inventions disclosed herein have been described with reference to the example embodiments described above, it should be understood that modifications and alterations will occur to others upon a reading and understanding of this specification without departing from the spirit and scope of the invention set forth in the appended claims. Example embodiments incorporating one or more aspects of the invention are intended to include all such modifications and alterations insofar as they come within the scope of the appended claims and their equivalents.

Moreover, while the foregoing description begins with a discussion of a lower-most component and concludes with a discussion of an upper most element, it should be understood that the order of discussion is not limiting and is only provided for ease of describing the various examples of dead front assemblies disclosed herein. Similarly, the positions (e.g., upper, lower) described herein are provided for ease of disclosing the illustrated embodiments. In this manner, it should be appreciated that positions would be different in other embodiments without departing from the scope of the present disclosure, for example, when viewing a dead front assembly from a different view than that which is shown in the drawings.

What is claimed is:

1. A dead front assembly for a user interface of a component, the dead front assembly comprising:
a masking layer including an opening defining a two-dimensional graphic;
a coating layer; and
a vacuum metalized layer disposed between the masking layer and the coating layer and configured to conceal the masking layer to thereby preserve an intended color of the coating layer,
wherein the coating layer is configured to match a flat, non-metallic color of said component and conceal the vacuum metalized layer.

2. The dead front assembly according to claim 1, wherein the vacuum metalized layer further comprises a metallic coating that is reflective to ambient light to thereby conceal the masking layer.

3. The dead front assembly according to claim 1, wherein the masking layer comprises an opaque ink configured to prevent light from passing through concealed portions of the masking layer.

4. The dead front assembly according to claim 1, wherein the coating layer comprises a non-black color adapted to match a color of said component in which the user interface is received.

5. A user interface for a component, wherein the user interface comprises:
an illumination element configured to transmit emitted light;
a molded component arranged proximate the illumination element; and
a dead front assembly disposed on the molded component, wherein the dead front assembly comprises:
a masking layer including an opening defining a two-dimensional graphic, wherein the emitted light is selectively transmitted through the opening to convey user information,
a coating layer configured to match a color of said component; and
a vacuum metalized layer disposed between the masking layer and the coating layer.

6. The user interface according to claim 5, wherein the vacuum metalized layer comprises a metallic coating that is reflective to ambient light to thereby conceal the masking layer.

7. The user interface according to claim 6, wherein the metallic coating is translucent such that the emitted light that is emitted from the illumination element may pass through the vacuum metalized layer.

8. The user interface according to claim 5, wherein the masking layer comprises an opaque ink configured to block the emitted light from passing through concealed portions of the masking layer.

9. The user interface according to claim 5, wherein the coating layer comprises a flat non-black and non-metallic color adapted to match a color of said component in which the user interface is received.

10. The user interface according to claim 5, wherein the coating layer comprises a single layer of ink.

11. The user interface according to claim 5, wherein the user interface further comprises a printed circuit board assembly, and wherein the illumination element is arranged on the printed circuit board assembly.

12. The user interface according to claim 11, wherein the user interface further comprises a capacitive sensor operable to selectively actuate the illumination element to display the user information.

13. The user interface according to claim 5, wherein a diffusion film is arranged between the illumination element and the masking layer and is configured to disperse the emitted light.

14. The user interface according to claim 5, wherein the dead front assembly further comprises an indicia layer, wherein the indicia layer further comprises visible iconography or text supplementing the user information.

15. The user interface according to claim 5, wherein the dead front assembly further comprises a hard coat layer, wherein the hard coat layer is an outer most layer of the dead front assembly and comprises a satin finish having a plurality of microscopic pores.

16. A method of forming a user interface of a component, the method comprising:
producing a dead front assembly by arranging a vacuum metalized layer between a coating layer configured to match the color of said component, and a masking layer defining a two-dimensional graphic for the passage of light therethrough; and
applying the dead front assembly onto a molded component forming part of the user interface.

17. The method according to claim 16, wherein the method further comprises printing a pressure sensitive adhesive beneath the masking layer, and applying the dead front assembly onto the molded component via the pressure sensitive adhesive.

18. The method according to claim 16, wherein the method further comprises applying the dead front assembly to the molded component during a plastic injection process to thereby fuse the dead front assembly to the molded component.

19. The method according to claim 16, wherein the method further comprises applying the dead front assembly to the molded component via a transfer foil during a plastic injection process.

20. The method according to claim 16, the method further comprising applying a hard coat layer about the dead front assembly, wherein the hard coat layer comprises a satin finish having a plurality of microscopic pores.
